(19) United States
(12) Patent Application Publication
(10) Pub. No.: US 2022/0187486 A1
(43) Pub. Date: Jun. 16, 2022

(54) COMPUTER SYSTEM AND DATA PROCESSING METHOD

(71) Applicant: Hitachi, Ltd., Tokyo (JP)

(72) Inventors: Shimei KO, Tokyo (JP); Shinji NAKAGAWA, Tokyo (JP); Yuji SUWA, Tokyo (JP); Kazuaki TOKUNAGA, Tokyo (JP)

(21) Appl. No.: 17/411,290

(22) Filed: Aug. 25, 2021

(30) Foreign Application Priority Data
Dec. 11, 2020 (JP) 2020-205762

(51) Int. Cl. G01V 1/30; G06N 3/08; G06F 17/18; G06F 7/50; G06F 7/523

(52) U.S. Cl. CPC G01V 1/305; G06N 3/08; G01V 2210/6222; G06F 7/50; G06F 7/523; G06F 17/18

(57) ABSTRACT

A computer system manages model information for defining a U-Net configured to execute, on the input time-series data, an encoding operation for extracting a feature map relating to the target wave by using downsampling blocks and a decoding operation for outputting data for predicting the first motion time of the target wave by using upsampling blocks, executes the encoding operation and the decoding operation on the input time-series data by using the model information. The downsampling blocks and the upsampling blocks each includes a residual block. The residual block includes a time attention block calculates a time attention for emphasizing a specific time domain in the feature map. The time attention block includes an arithmetic operation for calculating attentions different in time width, and calculates a feature map to which the time attention is added by using the attentions.

### CLAIM OF PRIORITY

The present application claims priority from Japanese patent application JP 2020-205762 filed on Dec. 11, 2020, the content of which is hereby incorporated by reference into this application.

### BACKGROUND OF THE INVENTION

This invention relates to a technology for analyzing an elastic wave.

In geological analysis, artificial vibration is applied to the ground, and an elastic wave propagating in the ground is measured. Then, a geological structure is analyzed based on, for example, the amplitude and propagation velocity of the measured elastic wave. When a first motion time of a freely-selected wave (target wave) is obtained from time-series data on the elastic wave, a propagation velocity of the target wave can be calculated.

Hitherto, a human has been obtaining the first motion time of the target wave from the time-series data of waves including various noises. The obtaining of the first motion time requires advanced knowledge and experience, is time-consuming, and depends on human ability. Therefore, there is demand for a technology for automatically calculating the first motion time. As a technology for analyzing the elastic wave, there are known such technologies as described in JP 2019-178913 A, and S. Mostafa Mousavi and three others, “A Deep Residual Network of Convolutional and Recurrent Units for Earthquake Signal Detection,” retrieved on Nov. 2, 2020 through the Internet.

JP 2019-178913 A includes the description that: “generating image data on an oscillatory wave image in which, on a matrix of an offset for identifying a separation distance of each of a plurality of geophones 12 from an artificial seismic source 11 and a travel time for identifying an elapsed time since the artificial seismic source 11 is caused to vibrate, a magnitude of an amplitude A obtained from an output signal of each of the geophones 12 is expressed in, for example, a gray scale; generating image data on a first motion image obtained by tracing a shape of a first peak waveform included in the oscillatory wave image; and inputting the image data on the oscillatory wave image as input data and the image data on the first motion image as teacher data, to an all-layer convolutional network for outputting, as output data, an image derived from features in the image data learned through use of teacher data.”

In S. Mostafa Mousavi and three others, “A Deep Residual Network of Convolutional and Recurrent Units for Earthquake Signal Detection,” retrieved on Nov. 2, 2020 through the Internet, there is disclosed a deep neural network including convolutional layers having a residual structure and long short-term memory (LSTM) units.

### SUMMARY OF THE INVENTION

In the technology described in JP 2019-178913 A, an image is handled as input, and it is required to prepare an image in advance. In addition, in the technology described in JP 2019-178913 A, the first motion time cannot be accurately calculated. The technology described in S. Mostafa Mousavi and three others, “A Deep Residual Network of Convolutional and Recurrent Units for Earthquake Signal Detection,” retrieved on Nov. 2, 2020 through the Internet is a technology relating to wave classification, and is not a technology for predicting the first motion time. In addition, in the technology described in S. Mostafa Mousavi and three others, “A Deep Residual Network of Convolutional and Recurrent Units for Earthquake Signal Detection,” retrieved on Nov. 2, 2020 through the Internet, it is required to convert the time-series data on a wave into a spectacle image through use of fast Fourier transform (FFT), thereby raising a problem of a high calculation cost.

This invention has an object to achieve a system and a method for predicting a first motion time of a wave with high accuracy while suppressing a calculation cost through use of time-series data.

A representative example of the present invention disclosed in this specification is as follows: a computer system for receiving time-series data as input and predicting a first motion time of a target wave. The computer system comprises at least one computer including an arithmetic unit and a storage device coupled to the arithmetic unit, and manages model information for defining a U-Net configured to execute, on the input time-series data, an encoding operation for extracting a feature map relating to the target wave through use of a plurality of downsampling blocks and a decoding operation for outputting data for predicting the first motion time of the target wave through use of a plurality of upsampling blocks. The at least one computer is configured to execute the encoding operation and the decoding operation on the input time-series data through use of the model information. The plurality of downsampling blocks and the plurality of upsampling blocks each including at least one residual block. The at least one residual block included in any one of the plurality of downsampling blocks and the plurality of upsampling blocks including a time attention block configured to calculate a time attention for emphasizing a specific time domain in the feature map. The time attention block including an arithmetic operation for calculating a plurality of attentions different in time width, and calculating a feature map to which the time attention is added through use of the plurality of attentions.

According to at least one embodiment of this invention, it is possible to predict the first motion time of the wave with high accuracy while suppressing the calculation cost through use of the time-series data. Other problems, configurations, and effects than those described above will become apparent in the descriptions of embodiments below.

### BRIEF DESCRIPTION OF THE DRAWINGS

The present invention can be appreciated by the description which follows in conjunction with the following figures, wherein:

FIG. 1 is a diagram for illustrating a configuration example of a computer system according to a first embodiment of this invention;

FIG. 2 is a diagram for illustrating a structure of a model in the first embodiment;

FIG. 3A is a graph for showing an example of time-series data on a wave input to the model in the first embodiment;

FIG. 3B is a graph for showing an example of data output from the model in the first embodiment;

FIG. 3C is a graph for showing an example of teacher data in the first embodiment;

FIG. 4A is a diagram for illustrating an example of a structure of a downsampling block in the first embodiment;

FIG. 4B is a diagram for illustrating an example of a structure of an upsampling block in the first embodiment;

FIG. 5 is a diagram for illustrating an example of a structure of a residual block in the first embodiment;

FIG. 6 is a graph for showing how a time attention in the first embodiment appears;

FIG. 7A, FIG. 7B, and FIG. 7C are diagrams for illustrating implementation examples of a channel attention block in the first embodiment;

FIG. 8A and FIG. 8B are diagrams for illustrating implementation examples of a time attention block in the first embodiment;

FIG. 9 is a flow chart for illustrating the processing to be executed by a learning module in the first embodiment;

FIG. 10 is a diagram for illustrating an example of data expansion processing to be executed by the learning module in the first embodiment;

FIG. 11 is a flow chart for illustrating the processing to be executed by a prediction module in the first embodiment; and

FIG. 12 is a graph for showing an example of time-series data on the probability in the first embodiment.

### DETAILED DESCRIPTION OF THE PREFERRED EMBODIMENTS

Now, a description is given of an embodiment of this invention referring to the drawings. It should be noted that this invention is not to be construed by limiting the invention to the content described in the following embodiment. A person skilled in the art would easily recognize that a specific configuration described in the following embodiment may be changed within the scope of the concept and the gist of this invention.

In a configuration of this invention described below, the same or similar components or functions are assigned with the same reference numerals, and a redundant description thereof is omitted here.

Notations of, for example, “first”, “second”, and “third” herein are assigned to distinguish between components, and do not necessarily limit the number or order of those components.

The position, size, shape, range, and others of each component illustrated in, for example, the drawings may not represent the actual position, size, shape, range, and other metrics in order to facilitate understanding of this invention. Thus, this invention is not limited to the position, size, shape, range, and others described in, for example, the drawings.

### First Embodiment

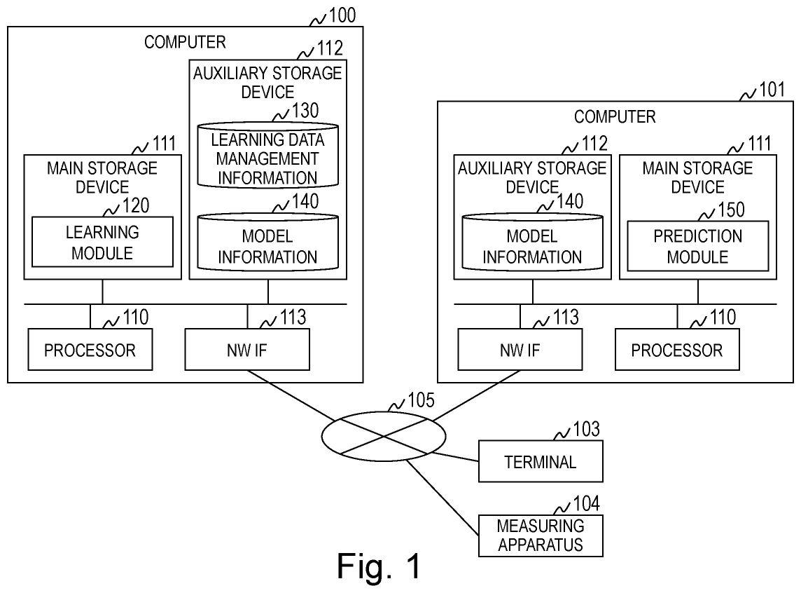

FIG. 1 is a diagram for illustrating a configuration example of a computer system according to a first embodiment of this invention.

The computer system includes computers 100 and 101, a terminal 103, and a measuring apparatus 104. The computers 100 and 101, the terminal 103, and the measuring apparatus 104 are coupled to one another through a network 105, for example, a wide area network (WAN) or a local area network (LAN).

The computer 100 learns a model to be used for predicting a first motion time of a freely-selected wave (target wave). The computer 101 receives time-series data on a wave in which a plurality of waves are superimposed on one another, and predicts the first motion time of the target wave through use of the learned model. For example, the computer 101 receives time-series data on an elastic wave propagating in the ground, and predicts the first motion time of a P wave.

The terminal 103 is a terminal to be used for operating the computers 100 and 101, and examples thereof include a personal computer, a smartphone, and a tablet terminal. A user uses the terminal 103 to, for example, register learning data and input the time-series data on a wave to be used for prediction. The measuring apparatus 104 measures the time-series data on the wave.

A system formed of a plurality of computers 100 may learn the model. In a similar manner, a system formed of a plurality of computers 101 may predict the first motion time of the target wave.

Now, hardware configurations and software configurations of the computers 100 and 101 are described.

The computer 100 includes a processor 110, a main storage device 111, an auxiliary storage device 112, and a network interface 113. Those hardware elements are coupled to one another through an internal bus.

The processor 110 executes a program stored in the main storage device 111. The processor 110 executes processing in accordance with the program, to thereby operate as a module for implementing a specific function. In the following description, when the processing is described with a module as the subject, the description indicates that the processor 110 is executing the program for implementing the module.

The main storage device 111 is a storage device, for example, a dynamic random access memory (DRAM), and stores a program to be executed by the processor 110 and information to be used by the program. The main storage device 111 is also used as a work area.

The main storage device 111 stores a program for implementing a learning module 120. The learning module 120 executes learning processing of the model.

The auxiliary storage device 112 is a storage device, for example, a hard disk drive (HDD) or a solid state drive (SSD), and permanently stores information.

The auxiliary storage device 112 stores learning data management information 130 and model information 140.

The learning data management information 130 is information for managing learning data to be used for the learning processing. The learning data includes time-series data on a wave input to a model and teacher data being a correct answer as output of the model.

The model information 140 is information for defining a model. The model information 140 includes values of various parameters. In the learning processing, the values of the parameters are updated based on a learning algorithm.

The programs and information stored in the main storage device 111 may be stored in the auxiliary storage device 112. In this case, the processor 110 reads the programs and information from the auxiliary storage device 112, and loads the programs and information into the main storage device 111.

The hardware configuration of the computer 101 is the same as that of the computer 100.

The auxiliary storage device 112 of the computer 101 stores the model information 140 transmitted from the learning module 120. The main storage device 111 of the computer 101 stores a program for implementing a prediction module 150. The prediction module 150 receives the time-series data on the wave, and predicts the first motion time of the target wave through use of the model information 140.

It is assumed that the time-series data on the wave, which is input to the prediction module 150, is input from at least any one of the terminal 103 or the measuring apparatus 104. When the computer 101 includes an input device, for example, a keyboard, a mouse, or a touch panel and an output device, for example, a display, the user may input the time-series data on the wave through use of the input device and the output device.

In regard to the modules of the computers 100 and 101, one module may be divided into a plurality of modules by the function. The modules of the computers 100 and 101 may be combined into one computer.

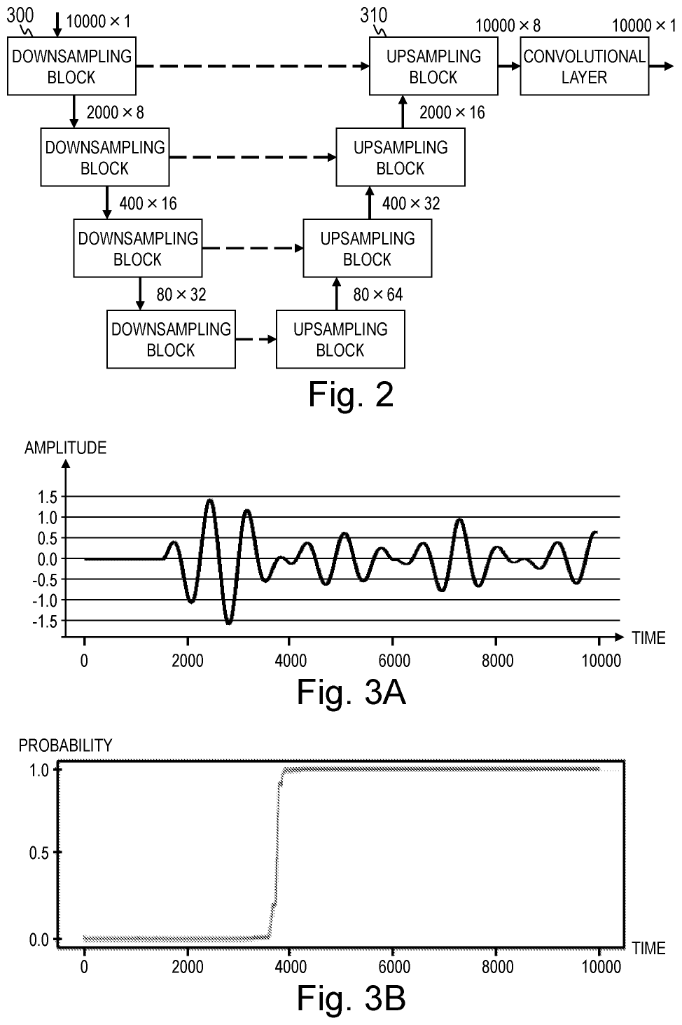

Next, a structure of the model defined in the model information 140 in the first embodiment is described with reference to FIG. 2 to FIG. 6.

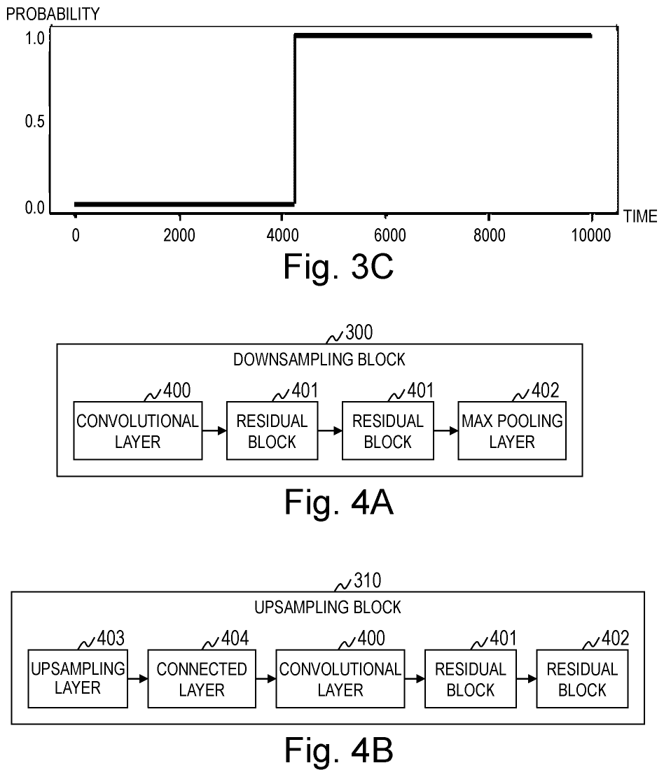

FIG. 2 is a diagram for illustrating a structure of a model in the first embodiment. FIG. 3A is a graph for showing an example of time-series data on a wave input to the model in the first embodiment. FIG. 3B is a graph for showing an example of data output from the model in the first embodiment. FIG. 3C is a graph for showing an example of teacher data in the first embodiment.

The model in the first embodiment is a model based on a U-Net described in Olaf Ronneberger and two others, “U-Net: Convolutional Networks for Biomedical Image Segmentation,” retrieved on Nov. 2, 2020 through the Internet. The model in the first embodiment includes four tiers of downsampling blocks 300 for implementing an encoding operation for extracting a feature, and four tiers of upsampling blocks 310 for implementing a decoding operation.

In this specification, a component for performing one kind of arithmetic operation is described as a “layer,” and a component for performing a plurality of kinds of arithmetic operations is described as a “block.”

Such time-series data on a wave as shown in FIG. 3A is input to the model. The time-series data on the wave is one-dimensional data, and in the time-series data on the wave of FIG. 3A, a time step (time width) representing a data size is 10,000.

In FIG. 2, the numbers by the solid arrows each represent numbers of time steps and channels of input or output data. For example, the time-series data on the wave having a time step of 10,000 is input to the downsampling block 300 in the first tier, and eight feature maps having a time step of 2,000 (the number of channels being 8) are output. The dotted arrows from the downsampling blocks 300 to the upsampling blocks 310 each indicate connection.

As described later, the model in the first embodiment is characterized in that an attention mechanism for calculating a time attention is incorporated into each of the downsampling blocks 300 and the upsampling blocks 310.

The model processes the time-series data on the wave, to thereby output such time-series data on a probability as shown in FIG. 3B, which indicates whether or not the target wave has arrived for each time step. The horizontal axis indicates the time step, and the vertical axis indicates the probability that the target wave has arrived. When the target wave has arrived, the probability is 1.

It is assumed that the learning data in the first embodiment includes such time-series data on the wave as shown in FIG. 3A and such teacher data as shown in FIG. 3C. The teacher data is a graph showing a value of 0 when the target wave has not arrived and a value of 1 when the target wave has arrived.

FIG. 4A is a diagram for illustrating an example of a structure of the downsampling block 300 in the first embodiment. FIG. 4B is a diagram for illustrating an example of a structure of the upsampling block 310 in the first embodiment.

The downsampling block 300 includes a one-dimensional convolutional layer 400, two one-dimensional residual blocks 401, and a one-dimensional max pooling layer 402. The structure of the downsampling block 300 illustrated in FIG. 4A is merely an example, and is not limited thereto. Some of the components may be excluded, or another component may be included. In addition, the order of input and output may be changed.

The upsampling block 310 includes a one-dimensional upsampling layer 403, a connected layer 404, a one-dimensional convolutional layer 400, and two one-dimensional residual blocks 401. The structure of the upsampling block 310 illustrated in FIG. 4B is merely an example, and is not limited thereto. Some of the components may be excluded, or another component may be included. In addition, the order of input and output may be changed.

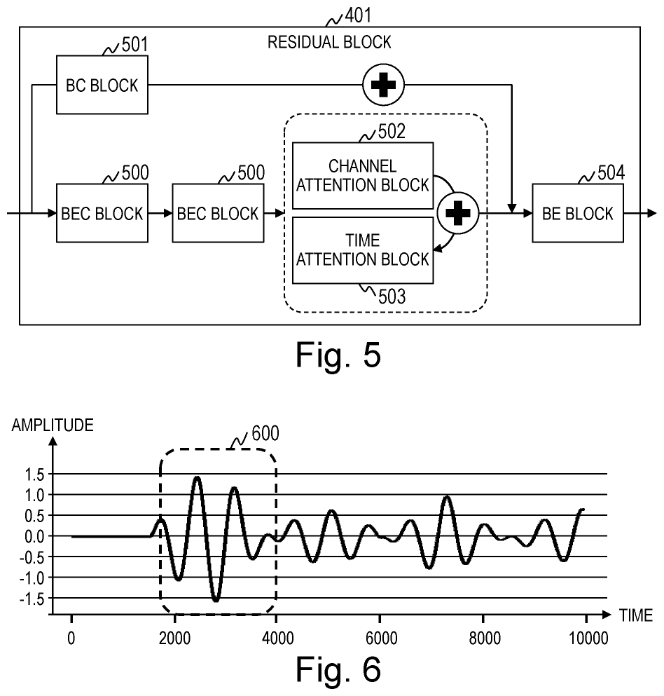

FIG. 5 is a diagram for illustrating an example of a structure of the residual block 401 in the first embodiment. FIG. 6 is a graph for showing how a time attention in the first embodiment appears.

The residual block 401 includes BEC blocks 500, a BC block 501, a channel attention block 502, a time attention block 503, and a BE block 504.

The BEC block 500 is a block for performing arithmetic operations using batch normalization, an exponential linear unit (ELU), and a one-dimensional convolutional layer. The BC block 501 is a block for performing arithmetic operations using batch normalization and a one-dimensional convolutional layer. The BE block 504 is a block for performing arithmetic operations using batch normalization and an ELU.

The residual block 401 in the first embodiment is characterized by including the channel attention block 502 and the time attention block 503 after the two BEC blocks 500.

The feature maps of a plurality of channels, which are output from the two BEC blocks 500, are input to each of the channel attention block 502 and the time attention block 503.

The channel attention block 502 outputs a feature map (feature map with attention) in which the feature map of a specific channel is emphasized. The time attention block 503 outputs a feature map (feature map with attention) in which a specific time width is emphasized. For example, the time attention block 503 outputs a feature map in which a time width 600 of FIG. 6 is emphasized.

In the residual block 401, output obtained by adding up the feature maps with attention from the channel attention block 502 and the time attention block 503 is added to the feature map output from the BC block 501. In the residual block 401, a feature map obtained by adding up a plurality of feature maps is input to the BE block 504.

The residual block 401 may include only the time attention block 503.

A model structure in which the channel attention block 502 and the time attention block 503 are included only in the residual block 401 of at least any one of the downsampling block 300 or the upsampling block 310 may be employed.

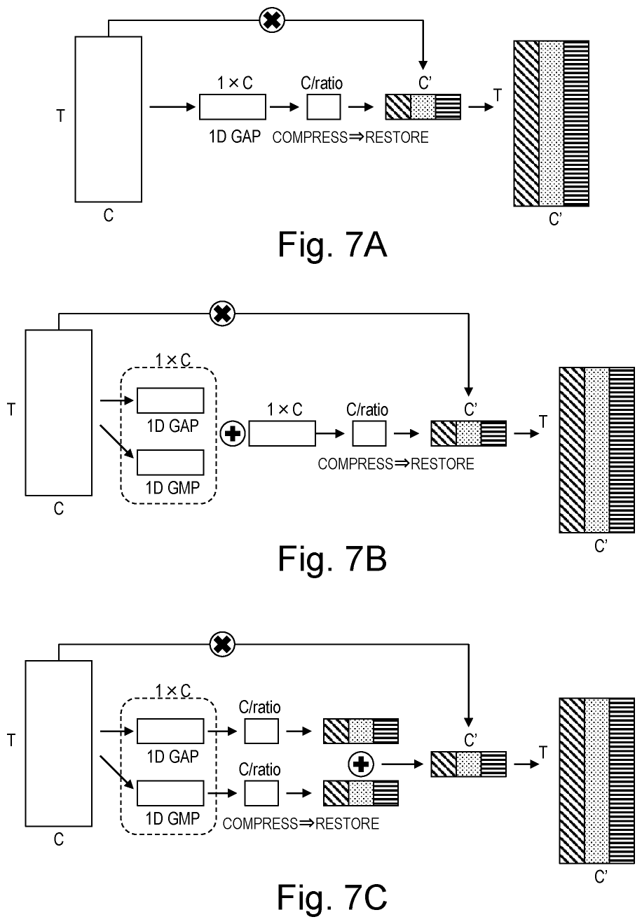

FIG. 7A, FIG. 7B, and FIG. 7C are diagrams for illustrating implementation examples of the channel attention block 502 in the first embodiment.

Two-dimensional data including feature maps having a size of a number (7) of time steps and corresponding to a number (C) of channels is input to the channel attention block 502 in the first embodiment.

The implementation example of FIG. 7A is described. The channel attention block 502 inputs the feature map to a one-dimensional global average pooling (GAP) layer to calculate an average value of all amplitudes of each channel. The channel attention block 502 inputs output of the GAP layer to a fully connected layer, to thereby compress the output, and also restores the compressed output to the number of channels before the conversion, to thereby calculate a channel attention. The channel attention block 502 also multiplies the feature map before the conversion by the channel attention to output a feature map to which the channel attention is added.

The implementation example of FIG. 7B is described. The channel attention block 502 inputs the feature map to the one-dimensional GAP layer and a one-dimensional global max pooling (GMP) layer to calculate an average value of all amplitudes of each channel. The channel attention block 502 inputs, after adding up average values of all amplitudes of each channel of each layer, the result of the addition to a fully connected layer, to thereby compress the output, and also restores the compressed output to the number of channels before the conversion, to thereby calculate a channel attention. The channel attention block 502 also multiplies the feature map before the conversion by the channel attention to output a feature map to which the channel attention is added.

The implementation example of FIG. 7C is described. The channel attention block 502 inputs the feature map to the one-dimensional GAP layer to calculate an average value of all amplitudes of each channel. The channel attention block 502 inputs output of the GAP layer to a fully connected layer, to thereby compress the output, and also restores the compressed output to the number of channels before the conversion, to thereby calculate a channel attention. The channel attention block 502 inputs the feature map to the one-dimensional GMP layer to calculate an average value of all amplitudes of each channel. The channel attention block 502 inputs output of the GMP layer to a fully connected layer, to thereby compress the output, and also restores the compressed output to the number of channels before the conversion, to thereby calculate a channel attention. The channel attention block 502 adds up the two channel attentions, and multiplies the feature map before the conversion by the added-up channel attentions to output a feature map to which the channel attention is added.

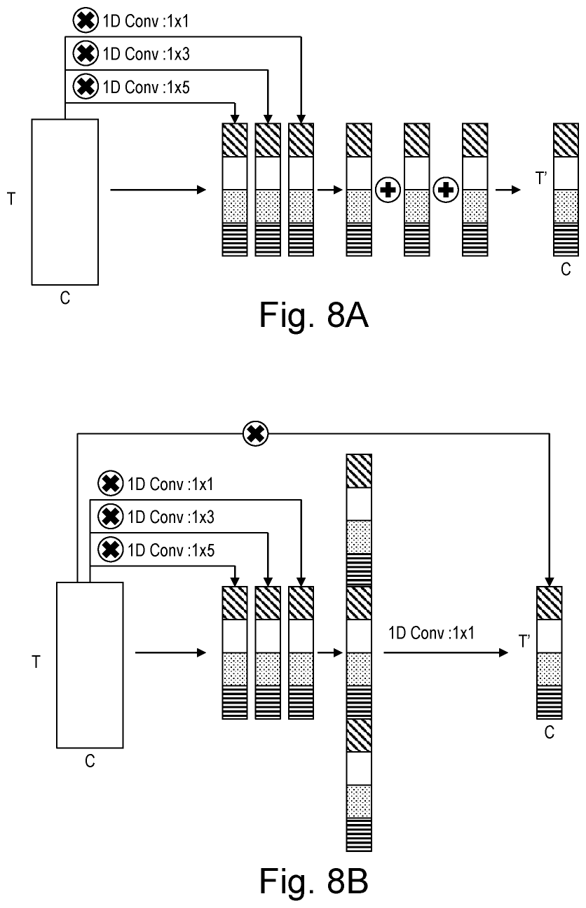

FIG. 8A and FIG. 8B are diagrams for illustrating implementation examples of the time attention block 503 in the first embodiment.

Two-dimensional data including feature maps having the size of the number (7) of time steps and corresponding to the number (C) of channels is input to the time attention block 503 in the first embodiment.

The implementation example of FIG. 8A is described. The time attention block 503 inputs the feature map to a plurality of convolutional layers having a pyramid structure and different scales to calculate attentions (feature maps). In this case, three convolutional layers of 1×1, 1×3, and 1×5 are used. The multiplication of numbers represents (dimension)×(kernel size). The time attention block 503 adds up the attentions for the scales to output a feature map to which the time attention is added.

The implementation example of FIG. 8B is described. The time attention block 503 inputs the feature map to a plurality of convolutional layers having a pyramid structure and different scales to calculate attentions (feature maps). In this case, three convolutional layers of 1×1, 1×5, and 1×5 are used. The time attention block 503 connects the attentions for the scales to one another, and inputs the connected attentions to a one-dimensional convolutional layer. The time attention block 503 multiplies the feature map before the conversion by the attention (the feature map) output from the one-dimensional convolutional layer to output a feature map to which the time attention is added.

A difference in scale corresponds to a difference in time width. The representation of features of a wave can be improved through use of attentions for various scales.

Next, processing to be executed by the learning module 120 and the prediction module 150 is described.

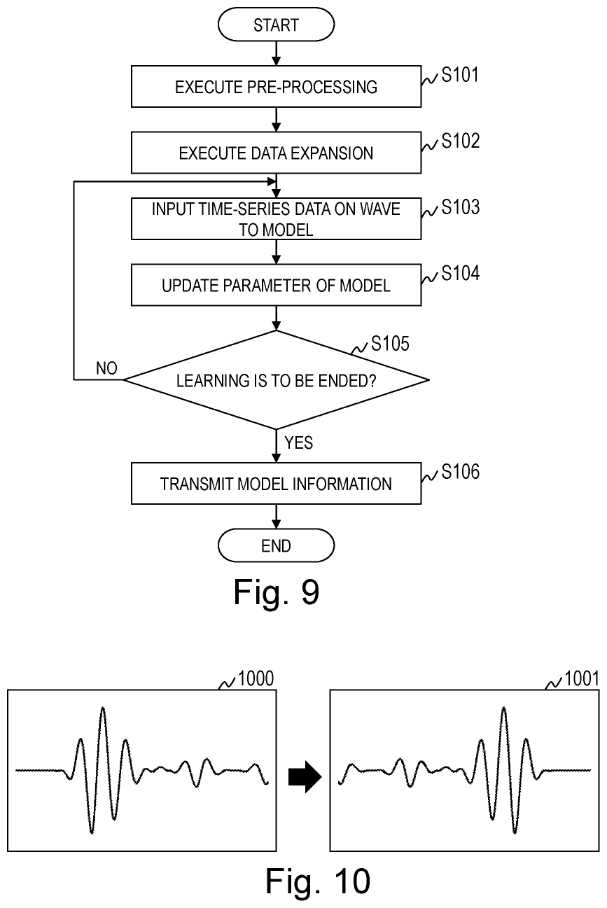

FIG. 9 is a flow chart for illustrating the processing to be executed by the learning module 120 in the first embodiment. FIG. 10 is a diagram for illustrating an example of data expansion processing to be executed by the learning module 120 in the first embodiment.

When the learning module 120 receives an execution instruction, the learning module 120 executes processing described below.

The learning module 120 executes pre-processing on time-series data on a wave forming learning data (Step S101). In the pre-processing, for example, data normalization is performed.

Subsequently, the learning module 120 executes data expansion processing on the learning data (Step S102).

Specifically, as illustrated in FIG. 10, the learning module 120 generates time-series data 1001 on an expansion wave by inverting time-series data 1000 on the wave in a time direction. At this time, teacher data is also inverted in the time direction in the same manner. The learning module 120 stores the time-series data on the expansion wave and expansion teacher data as learning data in the learning data management information 130. Thus, the learning data can be inflated.

Subsequently, the learning module 120 selects one piece of learning data, and inputs the time-series data on the wave forming this piece of learning data to the model (Step S103).

Specifically, the learning module 120 executes arithmetic operation processing on the time-series data on the wave through use of the model information 140. For example, as a result of the arithmetic operation processing on the time-series data on the wave shown in FIG. 3A, such time-series data on the probability as shown in FIG. 3B is output.

At this time, the learning module 120 may format the time-series data on the wave based on a data size handled by the model. For example, when the data size is large, the learning module 120 divides the time-series data on the wave, and executes the arithmetic operation on the divided time-series data on the wave. When the data size is large, the learning module 120 may move a window having a freely-set window width along a time axis, and input the time-series data on the wave within the window to the model.

Subsequently, the learning module 120 updates parameters of the model based on the learning algorithm using the output of the model and the teacher data (Step S104).

As the learning algorithm, a known algorithm, for example, a steepest descent method, is used. This invention has no limitation imposed on the learning algorithm to be used.

In the learning in the first embodiment, the parameters of the attention mechanism of the time attention block 503 are updated such that a time domain including the first motion time is emphasized.

Subsequently, the learning module 120 determines whether or not to end the learning (Step S105).

For example, the learning module 120 counts the number of times of learning, and determines to end the learning when the number of times of learning is larger than a threshold value. The learning module 120 also verifies prediction accuracy through use of data for test, and determines to end the learning when the prediction accuracy is larger than a threshold value.

In a case where it is determined that the learning is not to be ended, the process returns to Step S103, and the learning module 120 executes the same processing.

In a case where it is determined that the learning processing is to be ended, the learning module 120 transmits the model information 140 to the computer 101, and then ends the processing (Step S106).

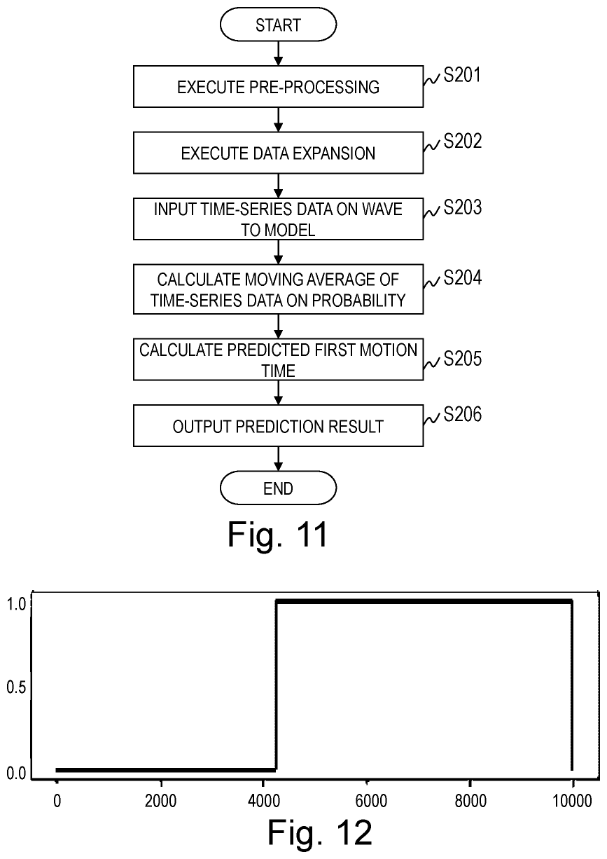

FIG. 11 is a flow chart for illustrating the processing to be executed by the prediction module 150 in the first embodiment. FIG. 12 is a graph for showing an example of time-series data on the probability in the first embodiment.

When the prediction module 150 receives input of the time-series data on the wave, the prediction module 150 executes processing described below.

The prediction module 150 executes pre-processing on the time-series data on the wave (Step S201). In the pre-processing, for example, data normalization is performed.

The prediction module 150 executes the data expansion processing on the time-series data on the wave (Step S202).

Specifically, as illustrated in FIG. 10, the learning module 120 generates the time-series data 1001 on the expansion wave by inverting the time-series data 1000 on the wave in the time direction.

Subsequently, the prediction module 150 inputs each of the time-series data on the wave and the time-series data on the expansion wave to the model (Step S203).

Specifically, the prediction module 150 executes arithmetic operation processing on the time-series data on the wave through use of the model information 140. For example, as a result of the arithmetic operation processing on the time-series data on the wave shown in FIG. 3A, such time-series data on the probability as shown in FIG. 3B is output. The pieces of time-series data on the two waves are input to the model, and hence the time-series data on the probability is output for the time-series data on each of the waves.

Subsequently, the prediction module 150 calculates a moving average of the time-series data on the probability (Step S204). In this case, a moving average is calculated for each of the two pieces of time-series data on the probability.

For example, when the moving average of the time-series data on the probability shown in FIG. 3B is calculated, such output as shown in FIG. 12 can be obtained.

Subsequently, the prediction module 150 calculates a predicted first motion time based on the moving average of the time-series data on the probability (Step S205).

Specifically, the prediction module 150 calculates the moving average of the probability for each of the pieces of time-series data on the two probabilities, and identifies an earliest time among times at each of which the moving average for a corresponding time step is larger than a threshold value (for example, 0.5). The prediction module 150 calculates an average value of the two times as the predicted first motion time.

Subsequently, the prediction module 150 outputs a prediction result including the predicted first motion time (Step S206), and then ends the processing.

For example, the prediction module 150 transmits the prediction result to the terminal 103. The prediction result may include the time-series data on the probability and the moving average of the time-series data on the probability, for example.

The prediction module 150 may output a prediction result including at least any one of the time-series data on the probability and the moving average of the time-series data on the probability without executing the processing of Step S205.

As described above, in the model in the first embodiment of this invention, the time attention block 503 is included, to thereby enable the arithmetic operation processing focusing on the time domain including the first motion time of the target wave. Thus, it is possible to predict the first motion time of the target wave with efficiency and high accuracy. Therefore, it is possible to automate analysis of an elastic wave, to thereby be able to reduce a cost required for the analysis and improve analysis accuracy.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, Python and Java.

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer system for receiving time-series data as input and predicting a first motion time of a target wave,
the computer system comprising at least one computer including an arithmetic unit and a storage device coupled to the arithmetic unit, and being configured to manage model information for defining a U-Net configured to execute, on the input time-series data, an encoding operation for extracting a feature map relating to the target wave through use of a plurality of downsampling blocks and a decoding operation for outputting data for predicting the first motion time of the target wave through use of a plurality of upsampling blocks,
the at least one computer being configured to execute the encoding operation and the decoding operation on the input time-series data through use of the model information,
the plurality of downsampling blocks and the plurality of upsampling blocks each including at least one residual block,
the at least one residual block included in any one of the plurality of downsampling blocks and the plurality of upsampling blocks including a time attention block configured to calculate a time attention for emphasizing a specific time domain in the feature map, and
the time attention block including an arithmetic operation for calculating a plurality of attentions different in time width, and calculating a feature map to which the time attention is added through use of the plurality of attentions.

2. The computer system according to claim 1, wherein the time attention block includes:
an arithmetic operation for inputting an input feature map to a plurality of convolutional layers having a pyramid structure to calculate a plurality of attentions; and
an arithmetic operation for adding up the plurality of attentions to calculate the feature map to which the time attention is added.

3. The computer system according to claim 1, wherein the time attention block includes:
an arithmetic operation for inputting an input feature map to a plurality of convolutional layers having a pyramid structure to calculate a plurality of attentions; and
an arithmetic operation for connecting the plurality of attentions to one another, inputting the connected plurality of attentions to a convolutional layer, and multiplying the input feature map by a feature map output from the convolutional layer to calculate the feature map to which the time attention is added.

4. The computer system according to claim 1, wherein the at least one computer is configured to:
output time-series data on a probability that the target wave has arrived, as an arithmetic operation result of the U-Net with respect to the input time-series data;
calculate a moving average of the time-series data on the probability; and
calculate an earliest time being a time at which the probability is larger than a threshold value as the first motion time of the target wave, based on the moving average of the time-series data on the probability.

5. The computer system according to claim 4, wherein the at least one computer is configured to:
generate expansion time-series data by inverting the input time-series data in a time direction; and
calculate the first motion time of the target wave based on a time identified based on the moving average of the time-series data on the probability corresponding to the input time-series data and a time identified based on the moving average of the time-series data on the probability corresponding to the expansion time-series data.

6. The computer system according to claim 1, wherein the at least one residual block included in any one of the plurality of downsampling blocks and the plurality of upsampling blocks comprises a channel attention block configured to calculate a channel attention for emphasizing a specific channel in the feature maps of a plurality of channels.

7. The computer system according to claim 1,
wherein the computer system is configured to hold learning data management information for managing learning data including time-series data for learning and teacher data indicating output of a correct answer of the U-Net, and
wherein the at least one computer is configured to execute learning processing for updating a parameter of the U-Net through use of the learning data.

8. A data processing method of predicting a first motion time of a target wave through use of time-series data, which is executed by a computer system,
the computer system comprising at least one computer including an arithmetic unit and a storage device coupled to the arithmetic unit,
the computer system being configured to manage model information for defining a U-Net configured to execute, on input time-series data, an encoding operation for extracting a feature map relating to the target wave through use of a plurality of downsampling blocks and a decoding operation for outputting data for predicting the first motion time of the target wave through use of a plurality of upsampling blocks,
the data processing method including:
a first step of receiving, by the at least one computer, input of the time-series data; and
a second step of executing, by the at least one computer, the encoding operation and the decoding operation on the input time-series data through use of the model information,
wherein the plurality of downsampling blocks and the plurality of upsampling blocks each includes at least one residual block,
wherein the at least one residual block included in any one of the plurality of downsampling blocks and the plurality of upsampling blocks includes a time attention block configured to calculate a time attention for emphasizing a specific time domain in the feature map, and
wherein the time attention block includes an arithmetic operation for calculating a plurality of attentions different in time width, and calculating the feature map to which the time attention is added through use of the plurality of attentions.

9. The data processing method according to claim 8, wherein the time attention block includes:
an arithmetic operation for inputting an input feature map to a plurality of convolutional layers having a pyramid structure to calculate a plurality of attentions; and
an arithmetic operation for adding up the plurality of attentions to calculate the feature map to which the time attention is added.

10. The data processing method according to claim 8, wherein the time attention block includes:
an arithmetic operation for inputting an input feature map to a plurality of convolutional layers having a pyramid structure to calculate a plurality of attentions; and
an arithmetic operation for connecting the plurality of attentions to one another, inputting the connected plurality of attentions to a convolutional layer, and multiplying the input feature map by a feature map output from the convolutional layer to calculate the feature map to which the time attention is added.

11. The data processing method according to claim 8, wherein the second step includes:
a third step of outputting, by the at least one computer, time-series data on a probability that the target wave has arrived, as an arithmetic operation result of the U-Net with respect to the input time-series data;
a fourth step of calculating, by the at least one computer, a moving average of the time-series data on the probability; and
a fifth step of calculating, by the at least one computer, an earliest time being a time at which the probability is larger than a threshold value as the first motion time of the target wave, based on the moving average of the time-series data on the probability.

12. The data processing method according to claim 11,
wherein the first step includes generating, by the at least one computer, expansion time-series data by inverting the input time-series data in a time axis direction,
wherein the third step includes outputting, by the at least one computer, the time-series data on the probability corresponding to the expansion time-series data,
wherein the fourth step includes calculating, by the at least one computer, a moving average of the time-series data on the probability corresponding to the expansion time-series data, and
wherein the fifth step includes calculating, by the at least one computer, the first motion time of the target wave based on a time identified based on the moving average of the time-series data on the probability corresponding to the input time-series data and a time identified based on the moving average of the time-series data on the probability corresponding to the expansion time-series data.

13. The data processing method according to claim 8, wherein the at least one residual block included in any one of the plurality of downsampling blocks and the plurality of upsampling blocks includes a channel attention block configured to calculate a channel attention for emphasizing a specific channel in the feature maps of a plurality of channels.

14. The data processing method according to claim 8,
wherein the computer system is configured to hold learning data management information for managing learning data including time-series data for learning and teacher data indicating output of a correct answer of the U-Net, and
wherein the data processing method further includes a step of executing, by the at least one computer, learning processing for updating a parameter of the U-Net through use of the learning data.
